(19) United States
(12) Patent Application Publication
(10) Pub. No.: US 2006/0171658 A1
(43) Pub. Date: Aug. 3, 2006

(54) More user friendly time-shift buffer

(76) Inventors: Robert Jochemsen, Eindhoven (NL); Adrianus J.M Denissen, Eindhoven (NL)

Correspondence Address: PHILIPS INTELLECTUAL PROPERTY & STANDARDS, 595 MINER ROAD, CLEVELAND, OH, 44143, US

(21) Appl. No.: 10/539,521

(22) PCT Filed: Dec. 8, 2003
(86) PCT No.: PCT/IB03/05900

§ 371 Date: Dec. 30, 2005

(51) Int. Cl. H04N 5/91; H04N 7/00

(52) U.S. Cl. 386/46

(57) ABSTRACT

A PVR device (10) having a varying size time-shift buffer (22) that provides a guaranteed minimum replay time for a more consistent consumer experience. The PVR device includes a video data storage means (24), a video input means (12), a video output means (32), a user input means (28), an input module (30) for receiving the video input data and writing the video input in the time-shift buffer (22), an output module (32) for reading the written video data from the time-shift buffer (22) and displaying it via the video output means (32) and a trimming module (42) for reducing the size of the time-shift buffer (22).

This invention relates to the display of video or audiovisual images from a streaming type of input over a period of time in a computer environment such as a Personal Video Recorder (PVR) and, in particular, to devices and methods wherein the video images may be displayed with features such as time delay and instant replay.

Multimedia devices such as VCRs, DVD players, MP3 players, cassette players, CD players and, in particular, PVRs have become popular with consumers in recent years. It is desirable for a user of time-varying video images displayed by VCRs, DVD players and PVRs to be able to pause the display of the video images. Previously, this has been done by halting the display when the user supplies an appropriate instruction, then beginning the display again, at the point at which the display was halted, when the user supplies another appropriate instruction. For pre-recorded video images (e.g., the video on a DVD disc), the implementation of such pausing is straightforward, since all of the video data is already stored on a storage medium and can be accessed as desired. The capability to pause the display of pre-recorded images has been implemented in most consumer electronics equipment that is used to display pre-recorded video images.

A difficulty is encountered in implementing the above-described conventional pausing method for images that are not pre-recorded, but, rather, are represented by video data that is only momentarily available to the video display system. This is the case, for example, with the broadcast of a television or radio program, or with a streaming type of input over a network such as the Internet or a local wireless network.

The current hard disk-based personal video recorder (PVR) systems offer a common technical feature known as the Time-shift Buffer. This time-shift buffer offers users features such as being able to pause the t.v. and perform an instant replay, and then to continue viewing from the point where the t.v. was paused. The time-shift buffer is always recording the channel that the user is watching, however, the oldest video in the buffer is continuously being discarded. Typical implementations in use today offer a fixed-time buffer having, for example, a one half hour total viewing time.

Current technologies having a fixed size time-shift buffer can, however, present difficulties or problems for a user. For example, if a user is watching with a time shift nearly equal to the fixed size of the time-shift buffer, the ability to go back further is severely hampered. As an example, if the time-shift buffer is fixed at 30 minutes and the user is watching with a time-shift of 29 minutes, the user can now only go back 1 more minute.

It is desirable, therefore, to provide a system and method that provides a time-shift buffer that is not fixed in size, in order to offer a guaranteed minimum replay time to a user of the system.

In accordance with one aspect of the present invention, a PVR device including a varying size time-shift buffer is provided, wherein the time-shift buffer provides a guaranteed minimum replay time. The PVR device includes video data storage, a video input, a video output, a user input, an input module, an output module and a trimming module for reducing the size of the time-shift buffer.

In accordance with another aspect of the present invention, a method for providing a user-friendly time-shift buffer is provided. The method includes acquiring input video data from a video input, extending a time-shift buffer on a recordable medium with the acquired video data, reading selected video data from the time-shift buffer, displaying the selected video data read from the time-shift buffer via a video output and trimming the time-shift buffer at a chronological beginning of the time-shift buffer, wherein the trimming does not reduce an available replay time below a guaranteed minimum replay time.

One advantage of the present invention is provided by the ability of the time-shift buffer to grow.

Another advantage is that if the user pauses the display even for extended duration, the time-shift buffer grows automatically if the user increases the length of a time delay when viewing.

Another advantage of the present invention is the ability to provide a guaranteed minimum replay time.

Yet another advantage is the more consistent consumer experience provided by the present invention.

Still further advantages of the present invention will become apparent to those of ordinary skill in the art upon reading and understanding the following detailed description of the preferred embodiments.

The invention may take form in various parts and arrangements of parts. The drawings are only for purposes of illustrating a preferred embodiment and are not to be construed as limiting the invention.

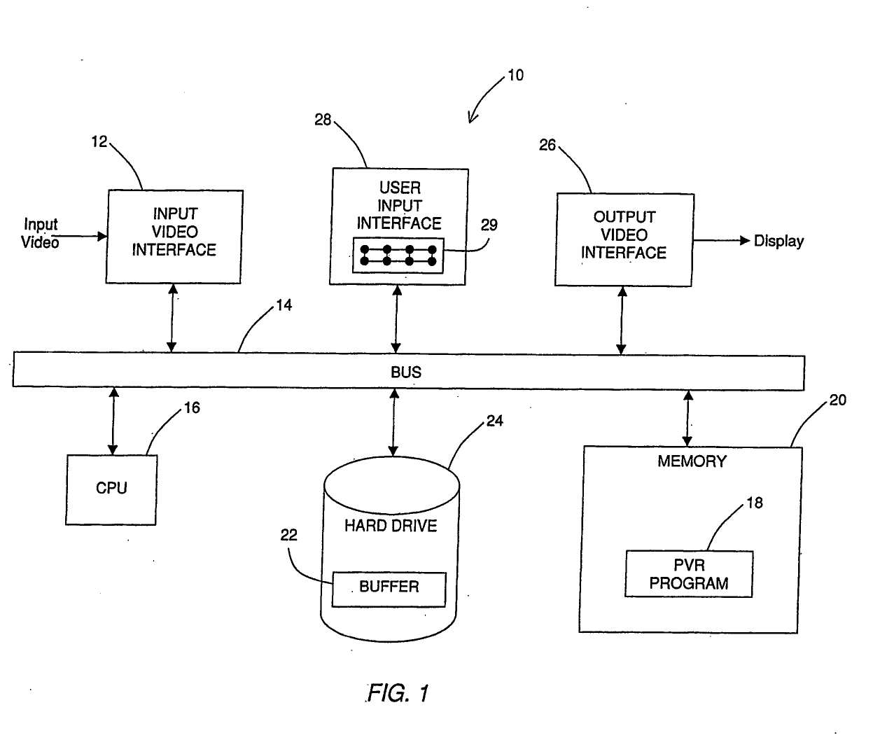

FIG. 1 is a block diagram of a PVR system in accordance with the present invention;

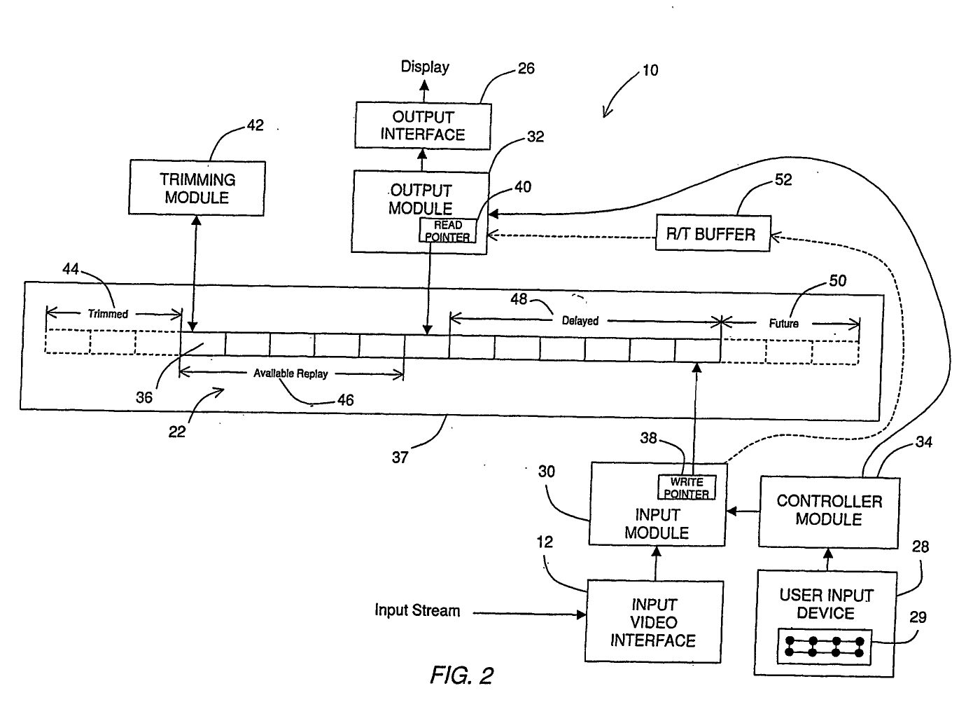

FIG. 2 is a schematic diagram of a PVR system according to a preferred embodiment of the present invention;

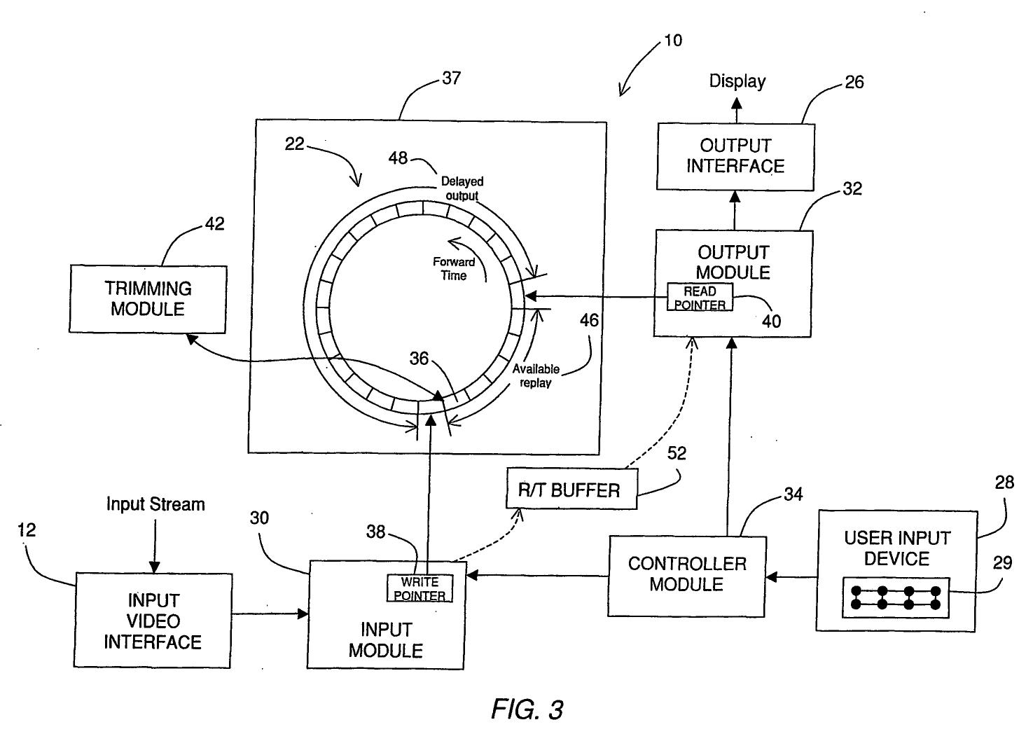

FIG. 3 is a schematic diagram of a PVR system according to an alternate embodiment of the present invention;

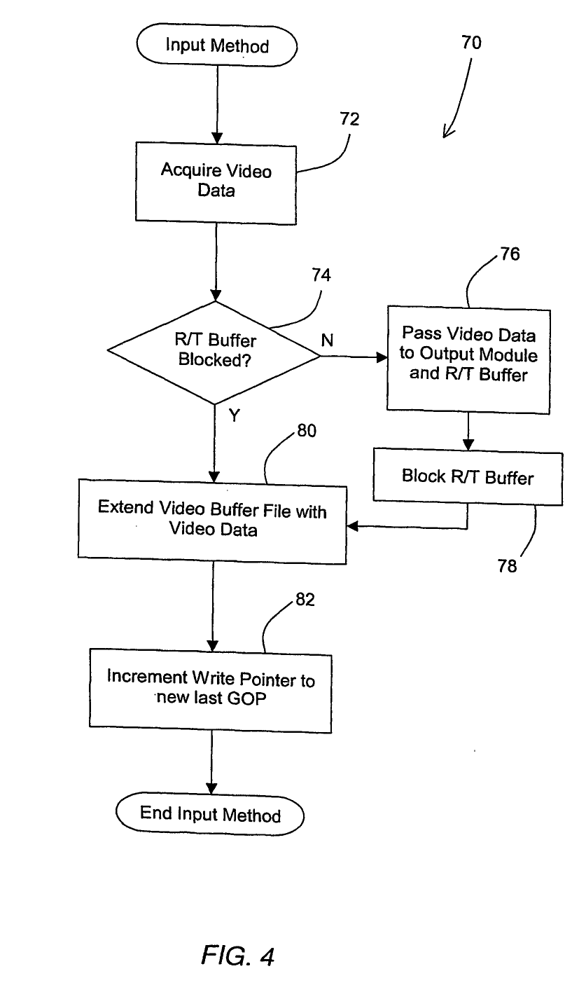

FIG. 4 is a flow chart of an input method according to an embodiment of the present invention;

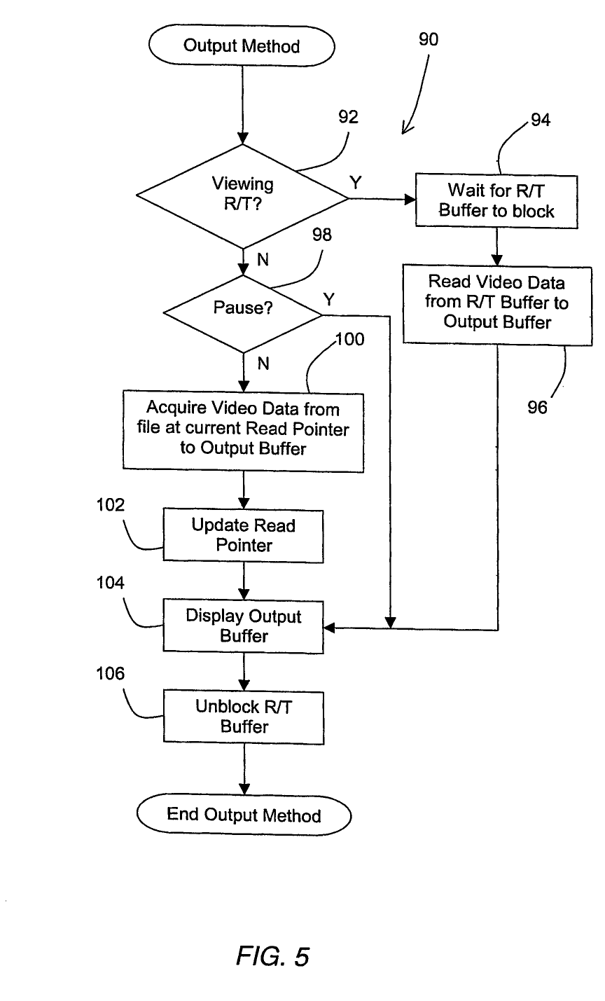

FIG. 5 is a flow chart of an output method according to an embodiment of the present invention; and

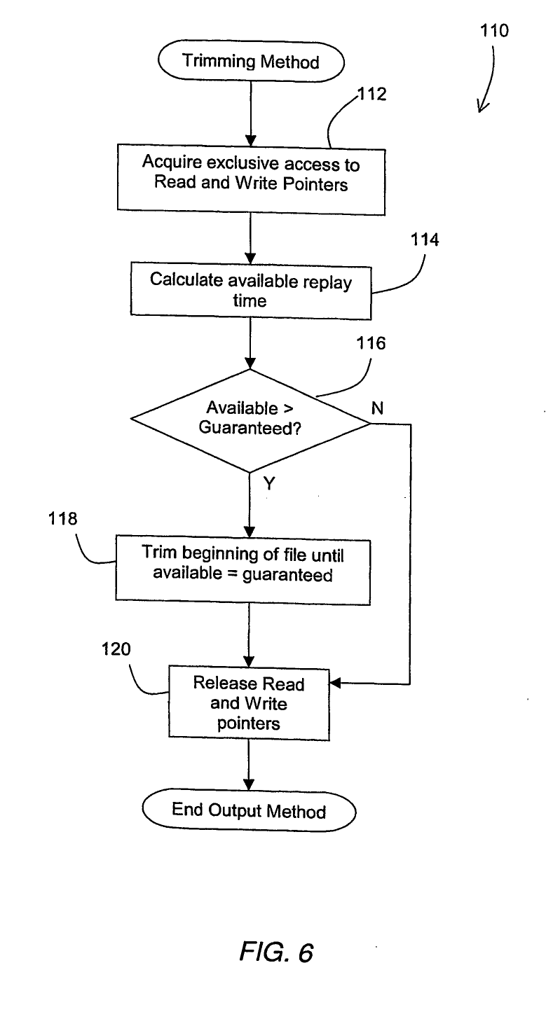

FIG. 6 is a flow chart of a trimming method according to an embodiment of the present invention.

With reference to FIG. 1, input video data is acquired from a video source by input video interface 12 and transmitted via system bus 14 under control of CPU 16 which is running a PVR program 18 residing in system memory 20. The video, under control of PVR program 18, is then written to time-shift buffer 22 residing on a hard disk 24 and subsequently, or simultaneously, transmitted to output video interface 26 for display on a user display device.

The time-shift buffer is not kept at a constant total size, but rather a constant size relative to the current playing position. For example, if the time-shift buffer is set to a size of 10 minutes, but the user is watching with a time shift of 15 minutes, the buffered video would be kept at 10+15 or 25 minutes. This solution has the advantage that the consumer gets a more consistent experience that is independent of the time shift with which the user is watching. While the time-shift buffer is described as being of a constant size relative to the current playing position, the constant size is with respect to frames, however, the size in terms of the number of bytes may vary.

Also shown in FIG. 1 is a user input interface 28 for receiving user input commands regarding events such as: pausing, replaying, or continuing in a normal or accelerated, fast-forward mode. Any number of input commands can be communicated via user controls 29 on user interface 28, as are typical in hand-held remote controllers.

When a user of the system 10 pauses the display of the image on the display device attached to the output video interface 26, the PVR program 18 directs the video received through the input video interface 12 via the system bus 14 to the time-shift buffer 22 on the hard disk 24. When the user ends the pause, the system PVR program 18 causes the stored displayed data in the time-shift buffer 22 to be transmitted from the hard disk 24 to the output video interface 26 via the bus 14. Essentially, simultaneously, incoming input video from input video interface 12 is written to the time-shift buffer 22 for viewing at an appropriate time. However, in order for the time-shift buffer 22 to not grow to an unacceptably large size, it is concurrently trimmed to maintain a selected size. If a user prefers, video information from the time-shift buffer 22 that has been delayed can be transmitted to the output video interface 26 in an accelerated mode so that, in time, the user is displaying essentially real time data with a minimal time delay.

With respect to the time delay, although it is desirable to minimize the time delay, it cannot be entirely eliminated due to hardware and other latency considerations. For example, it is difficult in a system to have a read position very close to a current write position. This results in a small, but sometimes noticeable delay, for example when changing channels and there is a momentary delay before the selected channel appears.

FIG. 2 provides a logical diagram of how the PVR program 18 (of FIG. 1) is organized and operates in conjunction with the disk buffer 22. The PVR program 18 includes an input module 30 for reading the video input, an output module 32 for providing the video output to output interface 26, and a controller module 34 for controlling the operation of the input module 30 and the output module 32. It is to be understood that the video input screen being received by the video input interface 12 may be in any number of video formats. It may be an analog video input or any number of digital video input formats. The input module 30 converts the input video stream to a preferred format for storing in video buffer 22.

The video-buffer 22 is sub-divided into individual segments known as a group of pictures (GOP). If, for example, the preferred video format for the video buffer 22 is MPEG2, each GOP will begin with an I-frame followed usually by a number of P and B frames. Each GOP can be as small as a single I-frame, but is usually no more than 15 frames in length for MPEG2. I-frames are intra-coded frames with an average 7 to 1 reduction ratio. P-frames are predicted based on prior I or P frames with the addition of data for changed macro blocks. P-frames average a 20 to 1 reduction ratio or about half the size of I frames. B-frames are bidirectionally predicted frames based on appearance with positions of past and future frame macro blocks. B-frames have less data than P-frames averaging about a 50 to 1 reduction ratio. In the case where MPEG4 is the selected format for the video buffer 22, each GOP 36 can be as large as the maximum key frame interval, usually 200 to 300 frames.

In the following description, references are made to video frames with respect to reading, writing and buffering. However, it is to be understood that, in many environments, operations may take place with chunks of data that include multiple frames, e.g., GOPs. Conversely, it is possible that one frame may comprise multiple packets of data. However, for ease of understanding the present invention, all descriptions herein are made with reference to frames but are intended to include implementations utilizing chunks or packets of data.

The video buffer 22 may be implemented utilizing all or part of a storage device, e.g. a hard drive, using functions developed specifically for the system 10. However, the video buffer 22 may also be implemented in existing files systems. For example, in one embodiment, the video buffer 22 is a regular file within a native file system under control of a file system module 37 of the particular operating system used for this embodiment. If the PVR system is implemented using a UNIX operating system, the video buffer 22 is preferably a regular file using a standard UNIX file system. If, however, the operating system is a LINUX operating system, the video buffer 22 is preferably a regular file written to, for example, the second extended file system (EXT2). If a BSD operating system is utilized, the video buffer 22 is preferably a regular file using the BSD file system. In this embodiment, any module acting upon time-shift buffer 22 communicates via system calls to file system module 37 in order to perform the desired actions.

In the preferred embodiment, the video buffer 22 is written utilizing the MPEG2 format and the input stream received from the video input interface 12 is also an MPEG2 format. However, it is to be understood that any number of input stream formats and any number of video formats for the video buffer 22 are also included within the scope of the present application.

As the input module 30 receives video frames from the video input interface 12, it writes individual frames to the video buffer 22 which has been previously described as a standard file in the native file system of the preferred operating system. The input module 30 maintains a write pointer 38 which is essentially a count of bytes or frames written to the video buffer 22. Essentially simultaneously, the output module 32 reads video frames from the video buffer and provides the output frames to the output interface 26 for display to a user on a display device.

The output module 32 maintains a read pointer 40 which is a pointer to the currently viewed frame in the video buffer 22. As the output module reads frames from video buffer 22, the read pointer 40 is incremented to the next frame in the video buffer. Furthermore, the input module 30 and the output module 32 operate under direction from the controller module 34. For example, a user with the user device 28 may wish to turn the personal video recorder system 10 off. In this case, the controller module 34 indicates to the input module 30 to close the video buffer 22 file and discontinue writing to the file. At the same time, the output module 32 discontinues providing the video frames to the output interface 26. Or, for example, in the case where a user wishes to pause the display momentarily, the controller module 34 then signals the output module 32 that it should suspend reading from the buffer 22 and continue displaying the currently read frame from the video buffer 22. In this case, however, the input module 30 continues to write frames to the video buffer 22.

In normal operation, in order to keep the size of the video buffer 22 from growing indefinitely, as the input module 30 writes new output frames to the buffer 22 at the end of the native file, a trimming module 42 removes frames from the beginning of the video buffer 22. These frames that have been trimmed from video buffer 22 are represented by the dashed segments indicated by numeral 44. In order to maintain a guaranteed replay time for the user, the trimming module 42 examines the read pointer 40 and calculates available replay time frames 46 by examining the displacement from the beginning of the file indicated by the read pointer 40. Then the trimming module 42 removes an appropriate number of frames from the beginning of the video buffer 22, and the read pointer 40 and the write pointer 38 are adjusted accordingly. The number of frames trimmed from the beginning of the file is reduced in number such that the read pointer 40 and the write pointer 38 represent displacements in bytes or frames from the beginning of the native file.

The trimming module 42, when trimming the beginning of the time-shift buffer 22 in a native file system, preferably performs the trimming in a manner that conforms to the file format of the system. Because of this, the trimming function does not always remove precisely the number of bytes requested, but instead removes the largest number of requested byes possible while abiding by allocation unit restrictions of the particular file system.

In the case where a user has paused the display momentarily and then resumed viewing, a disparity will occur between the read pointer 40 and the write pointer 38, indicating the delayed frames 48 when the user is viewing with a time delay. In this manner then, the video buffer 22 grows in size so that its total size includes a guaranteed available replay time represented by the frames 46 and a delayed time represented by the added frames 48. Thus, as the video buffer 22 is trimmed at the beginning of the file by trimming module 42, it concurrently grows at the opposite end of the video buffer 22 by records, frames or GOPs written by the input module 38. The future records, frames or GOPs which are not yet written to the video buffer 22 are represented by numeral 50.

The Video buffer 22 is represented in FIG. 2 in a linear fashion in order to distinguish it from the typical circular buffer used in existing PVRs. In the instant application, however, a native file is written and trimmed simultaneously, and essentially worms its way through free space in the native file system.

As an optional feature of the PVR system 10, when the user is viewing in real time, the input module 30 may simultaneously write to the video buffer 22 and place each video frame in a real-time buffer 52. Instead of reading frames from the video buffer 22, the output module retrieves frames directly from memory in the real-time buffer 52 for display. This improves the viewing experience by further minimizing any time delay caused by the aforementioned reaction latencies in the system. The real-time buffer 52 is preferably maintained in random access memory (not shown). Also, while the real-time buffer is shown with a single element, in typical implementations, the buffer includes multiple elements in the form of a queue.

FIG. 3 is a representation of an alternate embodiment of the present application similar to that shown in FIG. 2 wherein like numerals represent like elements or processes. However, the video buffer 22 is implemented in a different fashion in the embodiment illustrated in FIG. 3. Instead of being part of a single file in a native file system, each of the segments 36 in the video buffer 22 is a separate file. The video buffer 22 includes a plurality of files.

In this embodiment, the video buffer 22 is illustrated as a circular buffer. However, the buffer 22 can grow and shrink in size according to need. A methodology for growing or shrinking the video buffer 22 is similar to the embodiment illustrated in FIG. 2. However, in this embodiment, the input module 30, which utilizes the write pointer 38, has an associated file table 60 which represents file names in a chronological fashion, video time-wise.

If the user is viewing the video at a normal rate, the video buffer 22 neither grows nor shrinks. The write pointer 38 accesses files in a sequential fashion through the video buffer 22, recursively circulating through the file names in the file table 60. Essentially, simultaneously, the output module 32 accesses files indicated by the read pointer 40 which is also associated with file table 60 and recursively retrieves files from video buffer 22, with or without the output delay 48. If, however, the user indicates a desire to pause the output display, the read pointer 40 stops advancing through the video buffer 22. In order to maintain a guaranteed available replay time, files corresponding to files 46 are inserted into the video buffer 22. At the position in the file table 60 associated with the write pointer 38, new files are generated in the native file system and inserted in the file table 60. In this manner, the available replay time is not diminished and the video buffer 22 continues to grow while the user remains in a pause mode. If, however, a user resumes viewing at a normal rate with a fixed delay, the write pointer 38 and the read pointer 40 continue to advance in a circular fashion or a recursive fashion through the video buffer 22 by accessing files via the file table 60.

When the user subsequently advances the display at a faster rate by fast forwarding, skipping commercials, or jumping to real time viewing, the trimming module 42 removes files from file table 60 to reduce the available replay time to the guaranteed replay time. The video buffer 22 shrinks accordingly.

In FIG. 4, an input method 70 suitable for use in an implementation of the input module 30 is diagramed. In step 72, a video frame is acquired from the input video interface 12. Step 74 is an optional step for the above-described real-time buffer 52 in which a test is made to determine if the real-time buffer 52 has been blocked by the output module 32. If the buffer 52 has not been blocked, processing continues at step 76 which copies the video frame to the real-time buffer 52. Subsequently, in step 78, a real-time buffer 52 is blocked by input method 70. After optional steps 74-78, in step 80 the video buffer 22 is extended as the video frame is written to the video buffer 22, extending the file in the native file system with the currently acquired video frame. In step 82, the write pointer is incremented accordingly to represent the displacement to the new last frame in the video buffer 22.

In FIG. 5, an output method 90 suitable for implementation in output module 32 is diagramed. An optional step 92, determines if the user is viewing in real time without any delay. If the answer is [symbol] yes [symbol] , processing continues. In step 94, the output method 90 waits for the real-time buffer 52 to be blocked by the input method 70. After the buffer has been blocked by the input module or input method 70, a step 96 reads a video frame from the real-time buffer 52 for display on the output device. If a negative answer was determined in step 92, a step 98 determines if the user has requested a pause in the display. If no pause has been requested, processing continues at step 100 which acquires a video frame from the file representing video buffer 22, at a point represented by the read pointer 40, for display on the output device. In step 102, the read pointer is incremented to point to the video frame that will be next acquired. In all cases, processing continues at step 104 where the above-acquired video frame is displayed by being passed to the output interface 26. In optional step 106, the real-time buffer 52 is unblocked for subsequent processing by the input method 70.

In FIG. 6, a trimming method 110 suitable for the trimming module 42 is diagramed. In step 112 of the trimming method, exclusive access to the read pointer 40 and the write pointer 38 is acquired such that the input module 30 and the output module 32 are not accessing the pointers simultaneously. In step 114, the available replay time is calculated by examining the read pointer 40 with respect to the beginning of the file (FIG. 2) or by examining the read pointer 40 with respect to the write pointer 38 (FIG. 3). Subsequently, in step 116, the available replay time is compared to the guaranteed replay time. If the available exceeds the guaranteed replay time, step 118 is invoked to trim the beginning of the file to the point where the available replay time is equal to the guaranteed replay time. In any case, step 120 releases the read pointer 40 and the write pointer 38 for access by the output method 32 and the input method 30.

It is to be understood that, while the input module 30, the output module 32, the controller module 34, and the trimming module 42 have been shown and described as operating as independent processes in a- multi-threaded environment, the above-described modules may be combined into a single module operating as a single thread, in which the modules iteratively perform processing steps in a sequentially ordered manner.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A video recorder comprising:
means for recording input video data in a time-shift buffer on a portion of a recording medium;
means for reading video data from the time-shift buffer;
means for independently trimming video data at a chronological beginning of the time-shift buffer to maintain at least a guaranteed minimum available replay time between the chronological beginning of the time-shift buffer and the video data read at a current time;
means for pausing the reading of the video data from the time-shift buffer to pause a current read time;
means for independently enlarging the time-shift buffer at a chronological end of the time-shift buffer with currently input video data.

2. The video recorder as set forth in claim 1, wherein the time-shift buffer comprises a single file.

3. The video recorder as set forth in claim 2, wherein the recording medium is a hard drive.

4. The video recorder as set forth in claim 3, wherein the single file is maintained within a native file system of an operating system included on the video recorder.

5. The video recorder as set forth in claim 1, wherein the time-shift buffer includes a plurality of files.

6. The video recorder as set forth in claim 5, wherein the recording medium is a hard drive.

7. The video recorder as set forth in claim 6, wherein the plurality of files are maintained within a native file system of an operating system included on the video recorder.

8. The video recorder as set forth in claim 7, further including a means for performing operations on the plurality of files.

9. The video recorder as set forth in claim 1, further including:
means for terminating the pausing of the reading of video data, such that reading of the video data from the time-shift buffer is recommenced.

10. The video recorder as set forth in claim 1, further including:
means for fast-forwarding through the video data in the time-shift buffer; and
means for contracting the size of the time-shift buffer.

11. The video recorder as set forth in claim 1, further including:
a real-time buffer, the input module passing video data to the output module via the real-time buffer when a user is viewing in real time without a time delay.

12. A video recorder comprising:
a hard drive;
a varying size time-shift buffer on the hard drive, which provides a guaranteed minimum replay time;
an input module for receiving the video input data and writing the video input data to the time-shift buffer on the hard drive;
an output module for reading the written video from the time-shift buffer and displaying it via the output video interface; and
a trimming module for adjusting the size of the time-shift buffer, such that the size of the time-shift buffer is sufficient to maintain the guaranteed minimum replay time.

13. The video recorder as set forth in claim 12, such that the hard drive includes at least one standard file system for holding the time-shift buffer.

14. The video recorder as set forth in claim 13, further including a file system module for adding, deleting and maintaining files on the at least one standard file system.

15. The video recorder as set forth in claim 14, wherein the time-shift buffer comprises a single file.

16. The video recorder as set forth in claim 14, wherein the time-shift buffer includes a plurality of files.

17. The video recorder as set forth in claim 12, further including:
a first user control for alternately pausing and recommencing the reading of the video data from the time-shift buffer.

18. The video recorder as set forth in claim 17, further including a second user control for fast-forwarding the reading of the video data from the time-shift buffer.

19. The video recorder as set forth in claim 12, further including:
a read pointer utilized by the output module for pointing to the appropriate segment to be read from the time-shift buffer; and
a write pointer utilized by the input module for pointing to the appropriate segment to be written in the time-shift buffer.

20. The video recorder as set forth in claim 19, further including a real-time buffer, the input module passing video data to the output module via the real-time buffer when a user is viewing in real time without a time delay.

21. A method of time-shift buffering comprising:
recording input video data in a time-shift buffer on a portion of a recording medium;
reading video data from the time-shift buffer;
independently trimming video data at a chronological beginning of the time-shift buffer to maintain at least a guaranteed minimum available replay time between the chronological beginning of the time-shift buffer and the video data read at a current time;
pausing the reading of the video data from the time-shift buffer to pause a current read time;
independently enlarging the time-shift buffer at a chronological end of the time-shift buffer with currently input video data.

22. The method as set forth in claim 21, further including:
terminating pausing the reading of video data, such that reading of the video data from the time-shift buffer is recommenced; and
when the reading of the video data is recommenced, freezing a size of the time-shift buffer.

23. The method as set forth in claim 22, further including:
fast-forwarding through the video data in the time-shift buffer; and
contracting the size of the time-shift buffer.

24. The method as set forth in claim 21, further including:
fast-forwarding through the video data in the time-shift buffer; and
contracting the size of the time-shift buffer.

25. The method as set forth in claim 21, such that the input module, the output module and the trimming module operate as separate processes.

26. The method as set forth in claim 21, such that the input module, the output module and the trimming module operate as a single-thread process.

27. The method as set forth in claim 21, further including:
storing input video data in a real-time buffer; and
reading video data from the real-time buffer, such that the reading video data from the real-time buffer is performed when a user is viewing at a real-time rate without a time-delay.

28. A method for controlling the size of a time-shift buffer comprising:
writing current data to a chronological end of the time-shift buffer, thereby increasing the size of the time-shift buffer;
determining a size by which the time-shift buffer is to be reduced;
trimming a chronological beginning of the time-shift buffer by a largest possible size not exceeding the determined size.

29. The method as set forth in claim 28 wherein the writing and the trimming are performed within a native file system and the time-shift buffer conforms to standards of a file in the native file system.
